(19) United States
(12) Patent Application Publication
(10) Pub. No.: US 2026/0155714 A1
(43) Pub. Date: Jun. 4, 2026

(54) DEVICE FOR ELECTRICAL CONTACTING OF AN ELECTRIC MOTOR WINDING OF AN ELECTRIC MOTOR WITH A PRINTED CIRCUIT BOARD OF A MOTOR CONTROL UNIT

(71) Applicant: HANON SYSTEMS EFP DEUTSCHLAND GMBH, Bad Homburg v.d. Höhe (DE)

(72) Inventors: Jonas Ludwig Boch, Rüsselsheim (DE); Christian Roll, Frankfurt am Main (DE); Ludger Holtmann, Rosbach (DE)

(21) Appl. No.: 18/705,719

(22) PCT Filed: Oct. 6, 2022
(86) PCT No.: PCT/DE2022/100740

§ 371 Date: Apr. 29, 2024

(30) Foreign Application Priority Data
Dec. 20, 2021 (DE) 10 2021 133 914.6

(51) Int. Cl. H02K 11/33

(52) U.S. Cl. CPC H02K 11/33

(57) ABSTRACT

A device for electrical contacting of an electric motor winding of an electric motor with a printed circuit board of a motor control unit (ECU). The device has an electrical conductor element which can be arranged between the printed circuit board and a housing of the electric motor and thereby electrically contacts an electrical contact surface of the printed circuit board with the electric motor winding of the electric motor. The electric conductor element has a first connection element with a contact bending part facing the contact surface of the printed circuit board and a second connection element for electrical contacting at a connection position of the electric motor winding, wherein the electric conductor element is formed in regions as an elastic structure which compensates for a relative positioning of the contact surface of the printed circuit board with respect to the connection position of the electric motor winding.

### CROSS REFERENCE TO RELATED PATENT APPLICATIONS

This is a U.S. national phase patent application of PCT/DE2022/100740 filed Oct. 6, 2022 which claims the benefit of and priority to German Patent Application No. 10 2021 133 914.6, filed on Dec. 20, 2021, the entire contents of each of which are incorporated herein by reference.

### TECHNICAL FIELD

The invention relates to a device for electrical contacting of an electric motor winding of an electric motor with a printed circuit board of a motor control unit. The device serves in particular as an assembly device for electrical contacting between a contact plane of the printed circuit board and motor phases of an electric motor winding of an electric motor.

### BACKGROUND

An engine control unit (ECU) for an electric motor comprises electronics which takes over the control, regulation and monitoring of motor functions. The components of the electronics are applied to a printed circuit board and are electrically contacted with one another. For electrical contacting of an electric motor winding of an electric motor with a printed circuit board of the motor control unit, assembly devices are employed which permit compensation of the relative position between the contact plane of the printed circuit board and the contact region on the motor. The position compensation is necessary due to manufacturing/assembly tolerances of the respective components manufactured by different manufacturers. Thus, location deviations occur between the electrical contact region on the electric motor and the contact plane on the printed circuit board of the motor control unit, which must be compensated accordingly with the device for electrical contacting. In known solutions, such a position or location compensation takes place between the motor control unit and the contact region for electrical contacting on the electric motor by means of a spring element in the form of a spiral spring which is enclosed in housing elements which can be displaced into one another. Electrical contact elements for electrical contacting with the contact plane of the printed circuit board are received by the housing element which, in the assembled state, faces the contact plane of the printed circuit board. The spiral spring is pretensioned during assembly, so that it exerts a contact pressure on the contact plane of the printed circuit board of the motor control unit after assembly because of its pretension. In doing so, the contact elements are permanently contacted with the contact plane of the printed circuit board. At the same time, a position compensation takes place between the printed circuit board or the motor control unit and the contact region for electrical contacting of the electric motor windings of the electric motor by means of a longitudinal expansion of the spiral spring. The spiral spring is decoupled by the housing elements and as such is not provided as an electrical conductor between the printed circuit board and the electric motor winding. The contact pressure of the spiral spring acts on a hold-down device against the contact plane. The reduced force of the inserted contact element, which in turn has elastic properties, thus acts on the actual contact plane.

The electrical contact elements provided for electrical contacting, which can be formed as punched grids, have receptacles for electrical conductors. These receptacles for the electrical conductors have hitherto been formed in the form of cable lugs, so that the electrical conductors, which are contacted at their opposite end with the motor phases of the electric motor winding, are connected to the electrical contact elements.

The known solution for electrical contacting of an electric motor winding with a printed circuit board of the motor control unit thus has several electrical interfaces, as a result of which the risk of contacting problems and ohmic losses is increased. The high number of individual parts to be assembled also has a disadvantageous influence on the assembly process. A further disadvantage is that the procurement of the individual parts is associated with an increased outlay and with higher costs.

From the point of view of assembly, there is also the problem that an increased installation space is required for the electrical contacting with electrical conductors due to the receptacles formed on the electrical contact elements, which can have the shape of cable lugs. In particular, the space requirement is increased in the case of a receptacle formed radially to the contact plane of the control unit for contacting with electrical conductors.

A further disadvantage of the known solution is that, during the assembly of the electrical conductors, a deformation of the receptacles, for example by crimping, is required in order to fix the electrical conductors in the receptacles of the contact elements for the electrical contacting of the electric motor winding. The insertion of the electrical conductors into the receptacles and the fixing require additional assembly steps. In addition, the connections between the receptacle of the electrical contact elements and the electrical conductors are susceptible to vibrations. Thus, at the connection point between the receptacle and the electrical conductor, the electrical conductors can be released from the receptacle, as a result of which the electrical contacting between the printed circuit board of the motor control unit and the electric motor winding of the electric motor is interrupted.

A solution is requested with which the disadvantages known from the prior art can be overcome.

### SUMMARY

It is therefore the object of the invention to provide a device for electrical contacting of an electric motor winding of an electric motor with a printed circuit board of a motor control unit, which allows compensation of a relative position between an electric motor winding of an electric motor and a printed circuit board of a motor control unit, is easy to assemble and at the same time requires a reduced installation space.

The object is achieved by a device with the features as shown and described herein.

A device for electrical contacting of an electric motor winding of an electric motor with a printed circuit board of a motor control unit which is provided for controlling the electric motor is provided. According to the invention, the device has an electrical conductor element which can be arranged between the printed circuit board of a motor control unit and a housing of the electric motor and thereby electrically contacts an electrical contact surface of the printed circuit board of the motor control unit with the electric motor winding of the electric motor. The electrical conductor element has a first connection element with a contact bending part facing the contact surface of the printed circuit board. At the end of the electrical conductor element opposite the first connection element, a second connection element is provided for electrical contacting at a connection position of the electric motor winding. According to the invention, the electrical conductor element is formed in regions as an elastic structure which compensates for a relative positioning of the contact surface of the printed circuit board with respect to the connection position of the electric motor winding.

According to the concept of the invention, the conductor element which electrically connects the printed circuit board of the motor control unit and the electric motor winding of the electric motor is formed to be elastically deformable at least in regions, so that the electric conductor element as such compensates for a relative positioning of the printed circuit board with respect to the connection position of the electric motor winding. In other words, the electrical conductor element has an elastic structure formed in regions which makes it possible to compensate for location or positional displacements between the motor control unit and the electric motor, in particular between the printed circuit board of the motor control unit and the connection position for the electric motor winding on the electric motor.

The device according to the invention thus combines the function of the electrical conductor for electrical contacting of the printed circuit board of the motor control unit with the electric motor winding of the electric motor, as well as an elastic deformability for tolerance compensation or location compensation of a relative positioning of the printed circuit board of the motor control unit with respect to the electric motor winding.

The elastic structure of the electrical conductor element can preferably be formed between the first connection element and the second connection element. In this case, the elastic structure of the electrical conductor element in the assembled state of the device according to the invention can have a pretension in at least one spatial direction. The elastic structure can accordingly be formed such that it is tensioned during assembly for arrangement between the conductor element and the motor housing in order to exert the desired pretension.

The contact surface of the printed circuit board is an electrically conductive contact region in which an electrical contacting with the contact bending part of the electrical conductor element is made possible. Usually, the contact surface is a metallic surface area with a predetermined size and shape.

According to a design of the device according to the invention, it can be provided that the elastic structure of the electrical conductor element is formed in such a way that a relative positioning of the contact surface of the printed circuit board relative to the connection position of the electric motor winding in all spatial directions can be compensated for. According to this design of the elastic structure, an elasticity of the electrical conductor element is given in each spatial direction.

The material of the electrical conductor element is suitable for changing its shape under the action of force and for returning to the original shape when the acting force is eliminated.

According to one design of the device according to the invention, it can be provided that the electrical conductor element is formed as a bent flat conductor at least in the region of the elastic structure, wherein a width of the flat conductor is greater than a thickness of the flat conductor.

In order to achieve the elastic deformability, the elastic structure of the electrical conductor element can be spiral-shaped. Preferably, the elastic structure of the electrical conductor element can be formed as a spiral spring. In the region of the elastic structure formed as a spiral spring, the electrical conductor element can have a round cross section. According to a further design of the device according to the invention, it can be provided that the elastic spring structure of the electrical conductor element is meander-shaped. This design is particularly suitable for designs of the electrical conductor element in the form of a flat conductor in which the width is greater than its thickness. The cross section of the flat conductor can be rectangular or oval in the region of the elastic structure.

There are no restrictions with regard to the shape and geometrical design of the elastic structure, provided that they only permit elastic deformation in such a way that a location displacement between the printed circuit board of the motor control unit and the connection region of the motor winding of the electric motor can be compensated for and at the same time a sufficiently high pretension is exerted on the printed circuit board of the motor control unit and the surface opposite the printed circuit board in order to ensure the electrical contacting between the printed circuit board of the motor control unit and the electric motor winding of the electric motor.

The first connection element and the second connection element can be plastic parts moulded onto the electrical conductor element. The connection elements can thus be manufactured by injection moulding.

Preferably, the first connection element can have a counterholder facing the surface of the printed circuit board, which limits the contact pressure of the contact bending part of the electrical conductor element against the contact surface of the printed circuit board to the spring force exerted by the contact bending part. As a result, the contact pressure of the contact bending part on the contact surface of the printed circuit board is decoupled from the contact pressure exerted on the printed circuit board by the elastic structure. The pressure force exerted by the elastic structure of the electrical conductor element is transmitted directly to the printed circuit board by the counterholder. In this case, the pressing force of the contact bending part against the contact surface of the conductor element is substantially lower than the pressing force exerted by the elastic structure of the elastic conductor element due to the counterholder. The contact bending part has an elastically flexible structure which is pressed against the contact surface of the printed circuit board during assembly of the device. The bending structure of the contact bending part is formed on the end face of the first connection element such that it slightly projects beyond the counterholder arranged on the end face in the non-assembled state of the device. During the assembly of the device, the counterholder and the bending structure of the contact bending part are pressed against the printed circuit board, wherein the spring travel of the bending structure is limited by the counterholder.

The bending structure of the contact bending part can advantageously be formed such that it exerts a contact pressure on the contact surface of the printed circuit board which is smaller than the contact pressure exerted on the surface of the printed circuit board by the pretension of the electrical conductor element by means of the counterholder.

The contact bending part can preferably be a stamped part, in particular a lamellar comb.

Since the contact bending part of the electrical conductor element rests against the contact surface of the printed circuit board, the electrical contacting between the electrical conductor element and the printed circuit board is provided. At the opposite end of the electrical conductor element, the electrical contacting with the electric motor winding can be formed by various connections. For example, it can be provided that the electrical contacting between the electrical conductor element and the electric motor winding is formed at the connection position with a welded connection, an insulation displacement connection or a soldered connection.

According to an advantageous further development of the device according to the invention, it can be provided that the electrical conductor element is formed to be lockable with the first connection element on the printed circuit board. In this case, a plug receptacle in the form of a plug housing can be formed on the printed circuit board, wherein the first connection element forms a plug which can be inserted into the plug housing formed on the printed circuit board. Further, a locking can also be provided in that an elevation formed on the first connection element, which protrudes beyond the front edge of the counterholder, is formed to be insertable into the printed circuit board.

Since the device according to the invention is essentially integrally formed, the number of interfaces during electrical contacting is reduced, as a result of which the risk of ohmic losses can be kept low. In other words, the one-piece concept reduces the losses due to transition resistances. It is also advantageous that the integration of the elastic structure as a component of the electrical conductor element can reduce the overall size of the device compared with the solutions known from the prior art. Moreover, the device according to the invention permits a simplified assembly for electrical contacting of the printed circuit board with the electric motor winding, since the device according to the invention only has to be positioned between the printed circuit board and the connection position of the electrical contacting of the electric motor winding on the electric motor. The reduction in assembly steps leads to an overall reduction in costs.

### DESCRIPTION OF DRAWINGS

Further details, features and advantages of designs of the invention will become apparent from the following description of exemplary embodiments with reference to the associated drawings. Wherein:

FIG. 1: shows a schematic sectional representation of an exemplary embodiment of the device according to the invention for electrical contacting of an electric motor winding of an electric motor with a printed circuit board of a motor control unit,

FIG. 2: shows a perspective representation of the device according to the invention for electrical contacting of an electric motor winding of an electric motor with a printed circuit board of a motor control unit,

FIG. 3: shows a schematic top representation of a second exemplary embodiment of the device according to the invention, and

FIG. 4: shows a schematic top representation of a third exemplary embodiment of the device according to the invention.

### DESCRIPTION OF AN EMBODIMENT

Recurring features are characterised by the same reference numerals in the figures.

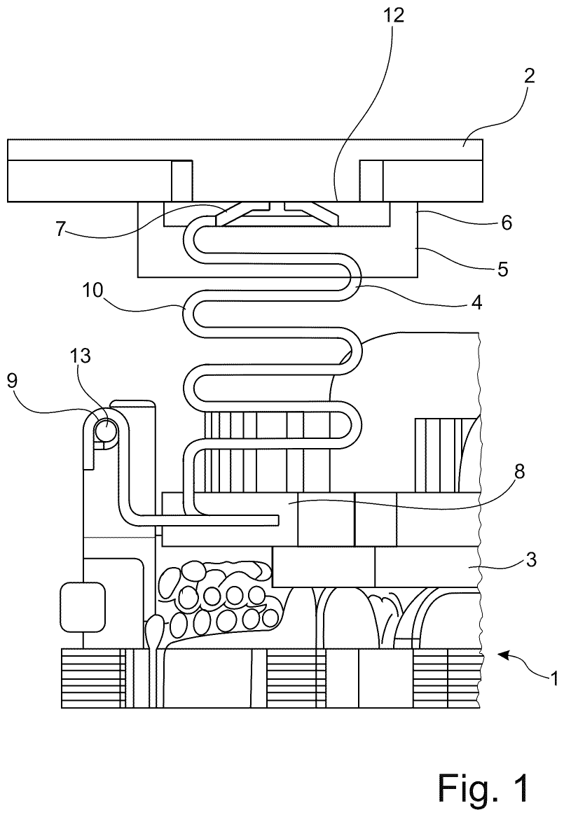

FIG. 1 shows a schematic sectional representation of an exemplary embodiment of the device according to the invention for electrical contacting of an electric motor winding 13 of an electric motor 1 with a printed circuit board 2 of a motor control unit. In the example shown, the device according to the invention is assembled between the printed circuit board 2 and the motor housing 3 of the electric motor 1. The device has an electrical conductor element 4 which has a first connection element 5 at one end facing the printed circuit board 2. The first connection element 5 is a moulded plastic part with an edge 6 which is formed on the end face and which serves as a counterholder with respect to the surface of the printed circuit board 2. The end of the electrical conductor element 4 accommodated in the first connection element 5 is formed as a contact bending part 7 with a bending structure which is contacted with a contact surface 12 of the printed circuit board 2 and thereby forms an electrical connection. At the opposite end of the electrical conductor element 4, a second connection element 8 is formed, which is also a moulded plastic part. The second connection element 8 is geometrically formed such that it is received in a receptacle of the motor housing 3 of the electric motor 1. A connection end of the electrical conductor element 4 is received by the second connection element 8 such that it is in contact with the electric motor winding 13 at a connection position 9. The connection position 9 is a region formed on the motor housing 3 for contacting the electrical conductor element 4 with an electrical conductor of the electric motor winding 13.

An elastic structure 10 of the electrical conductor element 4 is formed between the first connection element 5 and the second connection element 8. The electrical conductor element 4 is formed in the region of the elastic structure 10 as a flat conductor bent in a meander shape. The elastic structure 10 permits an elastic deformation of the electrical conductor element 4 in the region between the first connection element 5 and the second connection element 8 such that a relative positioning of the printed circuit board 2 with respect to the motor housing 3 or the connection position 9 is compensated both in the axial and in the radial direction. The elastic structure 10 has a pretensioning force in the assembled state. Due to the pretensioning force exerted by the elastic structure, the first connection element 5 presses against the contact region of the printed circuit board 2 with the contact bending part 7 formed on the end face of the connection element 5. The second connection element 8 located at the opposite end of the electrical conductor element 4 is held in position as a result of the contact pressure on the motor housing 3. The counterholder 6 formed on the end face of the first connection element 5 in the form of an edge transmits the pressing force exerted by the pretensioning force of the elastic structure 10 to the printed circuit board 10. The pressing force of the contact bending part 7 against the contact surface of the printed circuit board 2 is thus decoupled from the pressing force exerted by the pretensioning force of the elastic structure 10.

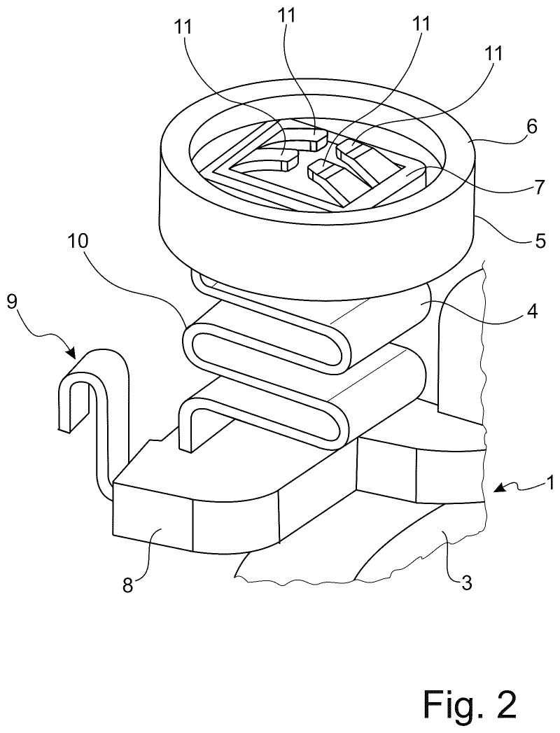

FIG. 2 shows a perspective representation of the device according to the invention for electrical contacting of an electric motor winding of an electric motor 1 with a printed circuit board 2 of a motor control unit. In contrast to FIG. 1, the printed circuit board 2 is not shown in the exemplary embodiment shown in FIG. 2 for a better explanation of the structure of the device according to the invention. The representation of FIG. 2 shows the device according to the invention with the first connection element 5 formed at the upper end of the electrical conductor element 4 in the form of a circular plastic part which is moulded onto the electrical conductor element 4. The connection end of the electrical conductor element 4 is formed such that it is received on the end face of the connection element 5 facing the printed circuit board 2 in the form of the contact bending part 7. The contact bending part 7 has a bending structure with pressure elements 11 which are bent slightly upwards for contacting with the contact surface of the conductor element 2 and, in the disassembled state, project beyond the end face of the counterholder 6 of the first connection element 5. The second connection element 8 formed at the opposite end of the electrical conductor element 4 is a plastic part moulded onto the electrical conductor element 4 and is inserted in the motor housing 3 of the electric motor 1 such that the connection end of the electrical conductor element 4 at the connection position 9 can be contacted with the electric motor winding of the electric motor 1. In the example shown, the electrical conductor element 4 is formed between the first connection element 5 and the second connection element 8 as a flat conductor bent in a meander shape, wherein the flat conductor bent in a meander shape forms an elastic structure 10 which makes it possible for the electrical conductor element 4 to be elastically deformable in the region between the first and the second connection element such that location displacements between the contact surface of the electrical circuit board 2 and the connection position 9 of the electric motor winding of the electric motor 1 can be compensated.

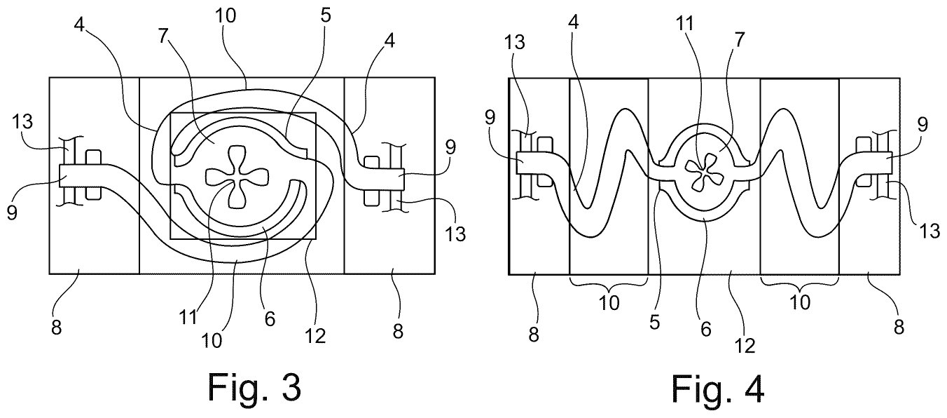

FIG. 3 shows a schematic plan view of a second exemplary embodiment of the device according to the invention, wherein the elastic structure 10 of the electrical conductor element 4 is spiral-shaped. FIG. 3 shows the device according to the invention in the assembled state, wherein the electrical printed circuit board 2 is not shown. The electrical conductor element 4 is contacted with the electric motor winding 13 of the electric motor 1 (not represented) at the connection positions 9. At the connection positions 9, the electrical conductor element 4 has second connection elements 8 in the form of moulded plastic parts. The reference numeral 12 shows the contact region of the printed circuit board 2 (not represented). The contact bending part 7 is contacted with the printed circuit board 2 in the contact region 12 with the pressure elements 11. In this case, the contact bending part 7 is received by the first connection element 5. A counterholder 6, which is formed as an end-projecting edge of the first connection element 5, limits the pressing force of the contact bending part 7 against the contact region 12. The elastic structure 10 compensates for position differences between the connection positions 9 and the contact region 12.

FIG. 4 shows a schematic plan view of a third exemplary embodiment of the device according to the invention. In contrast to the design shown in FIG. 3, the electrical conductor element 4 has a radially spiral spring in the region of the elastic structure 10. The elastic structure 10 in the form of radial spiral springs compensates for position differences between the connection positions 9 and the contact region 12.

### LIST OF REFERENCE NUMERALS

1 electric motor
2 printed circuit board
3 motor housing
4 electrical conductor element
5 first connection element
6 edge/counterholder
7 contact bending part
8 second connection element
9 connection position
10 elastic structure
11 pressure elements
12 contact region/contact surface
13 electric motor winding

1-12. (canceled)

13. A device for electrical contacting of an electric motor winding of an electric motor with a printed circuit board of a motor control unit, the device comprising:
an electrical conductor element which can be arranged between the printed circuit board and a housing of the electric motor and thereby electrically contacts an electrical contact surface of the printed circuit board with the electric motor winding of the electric motor, wherein the electrical conductor element has a first connection element with a contact bending part facing the contact surface of the printed circuit board and a second connection element for electric contacting at a connection position of the electric motor winding, the electrical conductor element being designed in regions as an elastic structure which compensates for a relative positioning of the contact surface of the printed circuit board with respect to the connection position of the electric motor winding.

14. The device according to claim 13, wherein the elastic structure of the electrical conductor element is formed between the first connection element and the second connection element.

15. The device according to claim 13, wherein the elastic structure of the electrical conductor element has a pretension in at least one spatial direction in an assembled state.

16. The device according to claim 13, wherein the elastic structure of the electrical conductor element is designed in such a way that a relative positioning of the contact surface of the printed circuit board with respect to the connection position of the electric motor winding can be compensated in all spatial directions.

17. The device according to claim 13, wherein the electrical conductor element is formed as a bent flat conductor at least in the regions of the elastic structure, a width of the flat conductor being greater than a thickness of the flat conductor.

18. The device according to claim 13, wherein the elastic structure of the electrical conductor element is spiral-shaped.

19. The device according to claim 13, wherein the elastic structure of the electrical conductor element is meander-shaped.

20. The device according to claim 13, wherein the first connection element and the second connection element are plastic parts molded onto the electrical conductor element.

21. The device according to claim 13, wherein the first connection element has a counterholder facing the contact surface of the printed circuit board, which limits a contact pressure of the contact bending part against the contact surface of the printed circuit board.

22. The device according to claim 13, wherein the electrical contacting between the electrical conductor element and the electric motor winding is formed with a welded connection, an insulation displacement connection, or a soldered connection.

23. The device according to claim 13, wherein the electrical conductor element can be locked to the printed circuit board with the first connection element.

24. The device according to claim 13, wherein the contact bending part is a die-cutting part.
